(19) United States
(12) Patent Application Publication
(10) Pub. No.: US 2020/0045058 A1
(43) Pub. Date: Feb. 6, 2020

(54) COMMUNICATION CONTROL SYSTEM, METHOD, AND NON-TRANSITORY RECORDING MEDIUM STORING INSTRUCTIONS FOR PERFORMING COMMUNICATION CONTROL METHOD

(71) Applicant: Takayasu Oe, Kanagawa (JP)

(72) Inventor: Takayasu Oe, Kanagawa (JP)

(73) Assignee: Ricoh Company, Ltd., Tokyo (JP)

(21) Appl. No.: 16/455,034

(22) Filed: Jun. 27, 2019

(30) Foreign Application Priority Data
Jul. 31, 2018 (JP) 2018-144312

(51) Int. Cl. H04L 29/06; H04L 12/26; G06F 16/906

(52) U.S. Cl. CPC H04L 63/145; H04L 63/1416; H04L 43/06; G06F 16/906; H04L 43/04

(57) ABSTRACT

A communication control system, method, and a machine-readable, non-transitory recording medium. The communication control system monitors communication of a plurality of communication devices, detects a first communication device that has made an unauthorized communication, searches for a second communication device having the same classification information as the first communication device, using classification information for classifying each communication device, issues an instruction to control communication of the first communication device and communication of the second communication device, and controls communication with the first communication device and communication with the second communication device in response to the instruction.

### CROSS-REFERENCE TO RELATED APPLICATIONS

This patent application is based on and claims priority pursuant to 35 U.S.C. § 119(a) to Japanese Patent Application No. 2018-144312, filed on Jul. 31, 2018 in the Japan Patent Office, the entire disclosure of which is hereby incorporated by reference herein.

### BACKGROUND

### Technical Field

The present disclosure relates to a communication control system, method, and a machine-readable, non-transitory recording medium storing instructions which, when executed by one or more processors, cause the processors to perform a communication control method.

### Background Art

A communication device such as a personal computer (PC) or a smartphone can connect to a network to access various information. If access destination information includes malicious software or malicious code (malware), the communication device may then also be infected with malware. When the communication device is infected, the malware may spread to other communication devices which have communicated with the infected communication device.

In order to prevent the spread of the infection, a technique for dynamically controlling the communication link of the communication device which has performed the communication after detecting an unauthorized communication has been proposed.

### SUMMARY

Embodiments of the present disclosure describe a novel communication control system, method, and machine-readable, non-transitory recording medium storing instructions which, when executed by one or more processors, cause the processors to perform a communication control method. The communication control system monitors communication of a plurality of communication devices, detects a first communication device that has made an unauthorized communication, searches for a second communication device having the same classification information as the first communication device, using classification information for classifying each communication device, issues an instruction to control communication of the first communication device and communication of the second communication device, and controls communication with the first communication device and communication with the second communication device in response to the instruction.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a diagram illustrating a configuration of a communication control system according to embodiments of the present disclosure;

FIG. 2 is a block diagram illustrating an example of hardware configuration of a management device included in the communication control system according to embodiments of the present disclosure;

FIG. 3 is a block diagram illustrating an example of a functional configuration of a communication control system;

FIG. 4 is a flowchart illustrating a communication control process executed by the communication control system;

FIG. 5 is a diagram illustrating a communication control process when a first unauthorized communication is detected;

FIG. 6 is a diagram illustrating a communication control process when a second unauthorized communication is detected;

FIG. 7A and FIG. 7B are diagrams illustrating examples of management information managed by a relay device that relays communication; and

FIG. 8 is a diagram illustrating an example of management information managed by the management device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

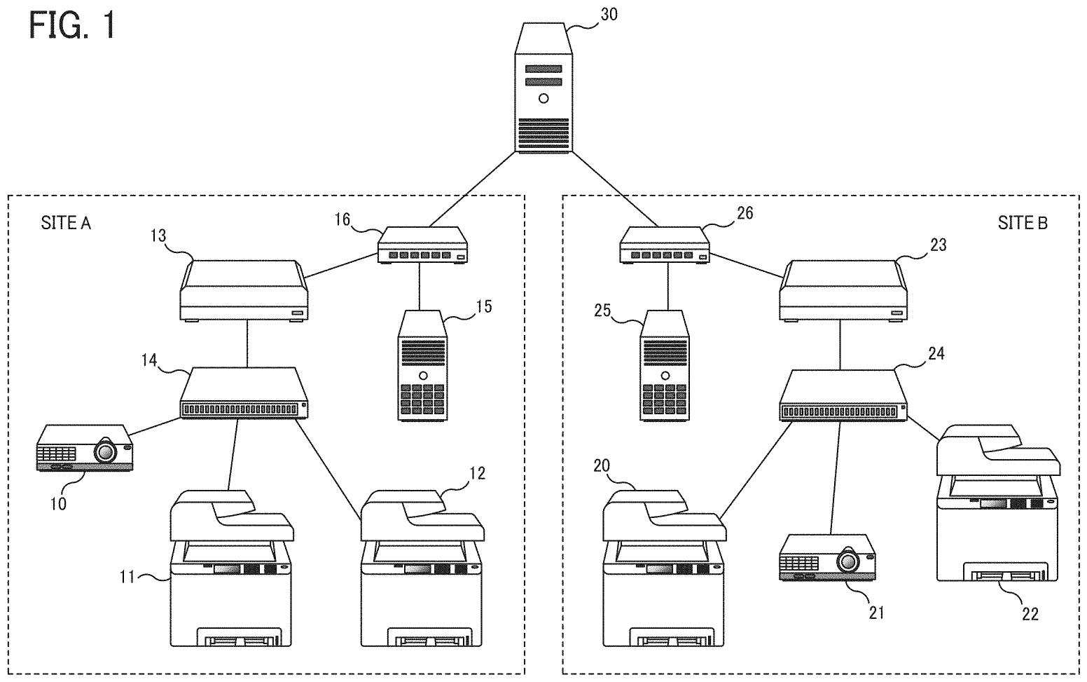

FIG. 1 is a diagram illustrating a configuration of a communication control system according to embodiments of the present disclosure. The communication control system illustrated in FIG. 1 is implemented in a network system to which Software Defined Networking (SDN), which is a technique for creating a virtual network environment, is applied. The network system includes two or more sites that communicate with each other. Note that although only two sites (SITE A, SITE B) are used in below description, the number of sites may be three or more.

Each site includes one or more communication devices. In the example illustrated in FIG. 1, the SITE A includes three communication devices 10 to 12, and the SITE B also includes three communication devices 20 to 22. The communication devices 10 to 12 and 20 to 22 may be any devices as long as the devices can communicate. Examples of the communication devices 10 to 12 and 20 to 22 may include a smartphone, a tablet terminal, a personal computer (PC), a digital camera, an electronic whiteboard, a printer, a copier, a multifunction peripheral (MFP), a projector (PJS) and the like. The respective communication devices 10 to 12 and 20 to 22 can be connected to a network such as the internet and communicate with other devices on the network, in addition to communicating with each other.

At each site, a technique called OpenFlow is applied to achieve dynamic control of the network. OpenFlow is a communications protocol that separates the two functions of data transfer and route control and is implemented by an SDN controller that performs control (route control) of a communication route and an SDN switch that performs data transfer. Therefore, the communication control system includes SDN controller and SDN switch, and is provided as the SDN controller 13, the SDN switch 14, the SDN controller 23, and the SDN switch 24 at each of the SITE A and SITE B.

At SITE A, three communication devices 10 to 12 are connected to the SDN switch 14, the SDN controller 13 is connected to the SDN switch 14, the SDN controller 13 issues an instruction to change communication route of each of the communication devices 10 to 12, and the SDN switch 14 switches the communication route to transfer data. The SDN controller 13 can instruct not only the change of the route but also the interruption of the communication. The aforementioned description applies also to SITE B.

The communication control system includes a virus detector that monitors the communication performed by each of the communication devices 10 to 12 and 20 to 22 and detects a communication device that has performed unauthorized communication. The virus detectors 15 and 25 are provided at the SITE A and SITE B, respectively. The communication device that has made an unauthorized communication is, for example, a device infected with malware. Hereinafter, the virus detectors 15 and 25 are described as devices that detect a communication device infected with a computer virus as an example of malware.

Communication between SITE A and SITE B is performed through relay devices 16 and 26. The virus detectors 15 and 25 are connected to the relay devices 16 and 26 and detect the virus of the communication device by communication through the relay devices 16 and 26.

The communication control system includes a management device 30 that manages communication between SITE A and SITE B. The management device 30 manages information of each of the communication devices 10 to 12 and 20 to 22 and instructs the SDN controllers 13 and 23 to control communication with the communication device infected with the virus detected by the virus detectors 15 and 25 among the plurality of communication devices 10 to 12 and 20 to 22. Control of the communication in this case involves shutting down communication with the communication device infected with the virus.

By shutting down the communication, it is possible to prevent other communication devices from being infected with the virus.

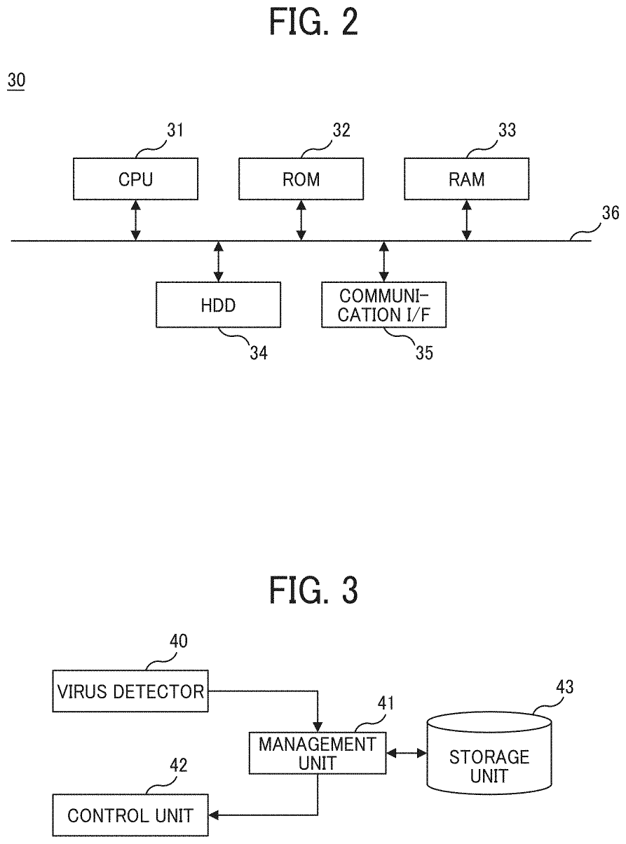

A hardware configuration of the management device 30 is described below with reference to FIG. 2. The communication devices 10 to 12 and 20 to 22, the SDN controllers 13 and 23, the virus detectors 15 and 25, and the relay devices 16 and 26 can adopt the same hardware configuration as the management device 30. Therefore, description of the hardware configuration of these devices is omitted.

The management device 30 includes, as hardware, a central processing unit (CPU) 31, a read only memory (ROM) 32, a random access memory (RAM) 33, a hard disk drive (HDD) 34, and a communication interface (I/F) 35. The CPU 31, the ROM 32, the RAM 33, the HDD 34, and the communication I/F 35 are connected to one another through a bus 36.

The CPU 31 is an arithmetic device that controls the overall operation of the management device 30, receives a notification of the detection result from the virus detectors 15 and 25 described above, and executes processing for instructing the SDN controllers 13 and 23. The ROM 32 is a read only non-volatile storage medium, and stores programs such as a boot program and firmware for controlling hardware.

The RAM 33 is a volatile storage medium capable of high-speed reading and writing of information and is used as a work area when the CPU 31 processes data. The HDD 34 is a non-volatile storage medium capable of reading and writing information, and stores an operating system (OS), a program for executing the above processing, and the like. The communication I/F 35 is connected to the network and controls transmission and reception of data. Ethernet (registered trademark), Universal Serial Bus (USB) interface or the like can be used for the communication I/F 35.

The management device 30 may include a display device such as a liquid crystal display (LCD), an input device such as a keyboard and a mouse, an audio input device such as a microphone, an audio output device such as a speaker, an imaging device such as a camera, and the like as other hardware.

The communication control system implements functions for controlling communication by executing programs implemented in each of the SDN controllers 13 and 23, the SDN switches 14 and 24, the virus detectors 15 and 25, and the management device 30. Note that the present disclosure is not limited to the program, and some or all of the functions may be implemented by hardware such as an integrated circuit.

FIG. 3 is a block diagram illustrating an example of a functional configuration of a communication control system. The communication control system includes a virus detector 40, a management unit 41, a control unit 42, and a storage unit 43 as functional units. The storage unit 43 may be provided as needed.

The virus detector 40 monitors communication of a plurality of communication devices and detects a virus of the communication device. The virus detector 40 stores, for example, a plurality of patterns for detecting the virus, and detects the virus of the communication device by comparing each pattern with data (file) transmitted and received in communication. Note that this method is but an example, and any method known to date can be adopted as long as virus can be detected.

The management unit 41 receives a notification from the virus detector 40 that the virus of the communication device has been detected, and instructs the control unit 42 to control, that is, shut down communication with the communication device.

In response to the instruction from the management unit 41, the control unit 42 shuts down communication with the communication device in which the virus is detected by the virus detector 40.

The management unit 41 uses the storage unit 43 to manage classification information for classifying each of the plurality of communication devices 10 to 12 and 20 to 22. The management unit 41 refers to the classification information stored in the storage unit 43, and searches for a communication device having the same classification information as the communication device in which a virus is detected by the virus detector 40. The communication devices searched here are communication devices not infected with the virus. The management unit 41 instructs the control unit 42 to control, that is, to shut down communication of the uninfected communication device. This is performed simultaneously with or following the instruction to shut down the communication device infected with the virus.

In response to receiving this instruction, the control unit 42 shuts off the uninfected communication device simultaneously or following the shut down of the communication device infected with the virus.

The classification information includes at least information indicating a device type to classify the same type of device that may be infected with the same virus. The device type is PC, MFP, PJS or the like, and may further include information such as the model of the device or the version of the OS in order to classify the communication device more precisely. The device type, model, and OS version are but examples of the classification information, and the classification information is not limited to these examples.

When the virus detector 40 detects a second communication device infected with the virus, the management unit 41 issues an instruction to search for communication devices that have the same classification information as the first and second communication devices and controls communication with the second communication device and communication with the communication device having the same classification information as the first and second communication devices. In this way, similarly for the third and subsequent units, communication of the N-th (where N is an integer of 3 or more) communication device, and communication of the communication devices having the same classification information as the first, second, to N-th communication device can be controlled. Communication with uninfected communication devices can be shut down and virus of these communication devices can be prevented.

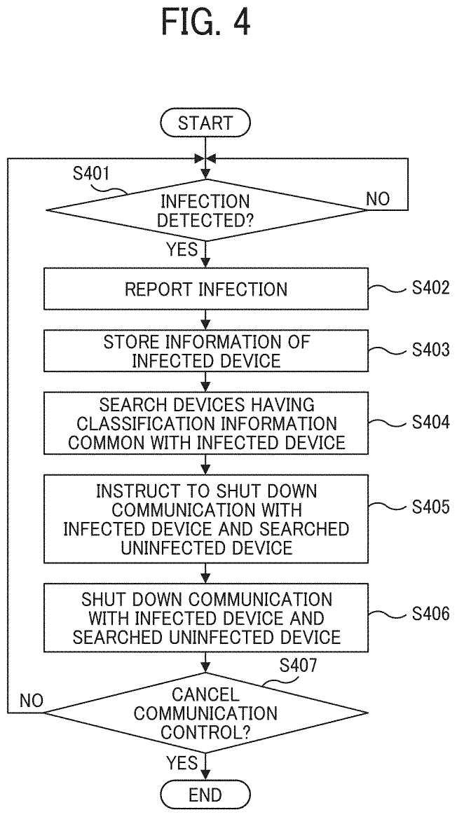

The communication control performed by the communication control system is described in detail with reference to FIG. 4. The communication control system starts control from step 400 by, for example, turning on the power of all the constituent devices or instructing start of control, or the like. In step S401, the virus detector 40 monitors communication with each communication device and confirms whether a virus of the communication device has been detected. When no virus is detected, step S401 is repeated until a virus of the communication device is detected.

In step S402, the virus detector 40 notifies the management unit 41 that a virus is detected on a communication device.

In step S403, the management unit 41 stores information on the detected communication device. The information of the communication device to be stored is, for example, a device identifier (ID). The information of the communication device may be stored in the storage unit 43, or when the management unit 41 includes a storage space, the storage space may be used.

In step S404, the management unit 41 refers to the storage unit 43, acquires the device IDs of all the communication devices detected so far, and based on the device ID, uninfected communication device having the same classification information as the virus infected communication device is searched. When there is no uninfected communication device having the same classification information as the virus infected communication device, the search result is regarded as none.

In step S405, the management unit 41 instructs the control unit 42 to shut down communication between the communication device detected in step S401 and the uninfected communication device searched in step S404. When there is no uninfected communication device found, the management unit 41 issues an instruction to shut down only the detected communication device. When there is a plurality of uninfected communication devices that have been found, the management unit 41 issues an instruction to shut down all of the detected communication devices and the plurality of uninfected communication devices found. Here, the management unit 41 may send instructions to the control unit 42, one by one for each of the communication device to be controlled. Alternatively, one or more instructions may be sent collectively.

In step S406, in response to the instruction from the management unit 41, the control unit 42 shuts down communication with the instructed communication device. When communication with the instructed communication device is already shut down, the control unit 42 shuts down communication with the remaining communication device.

In step S407, the communication control system determines whether to cancel the communication control. The communication control can be canceled by receiving an instruction to cancel the communication control, or by the occurrence of an error or power-off of any of the devices included in the communication control system. When the communication control is not canceled, the process returns to step S401, and when the communication control is canceled, the process proceeds to step S408 and

In addition, the management unit 41 stores the information of the uninfected communication device instructed to shut down the communication in the storage unit 43, compare with the information of the uninfected communication device retrieved, identify the uninfected communication device not instructed to shut down yet, and may instruct to shut down communication with the identified uninfected communication device.

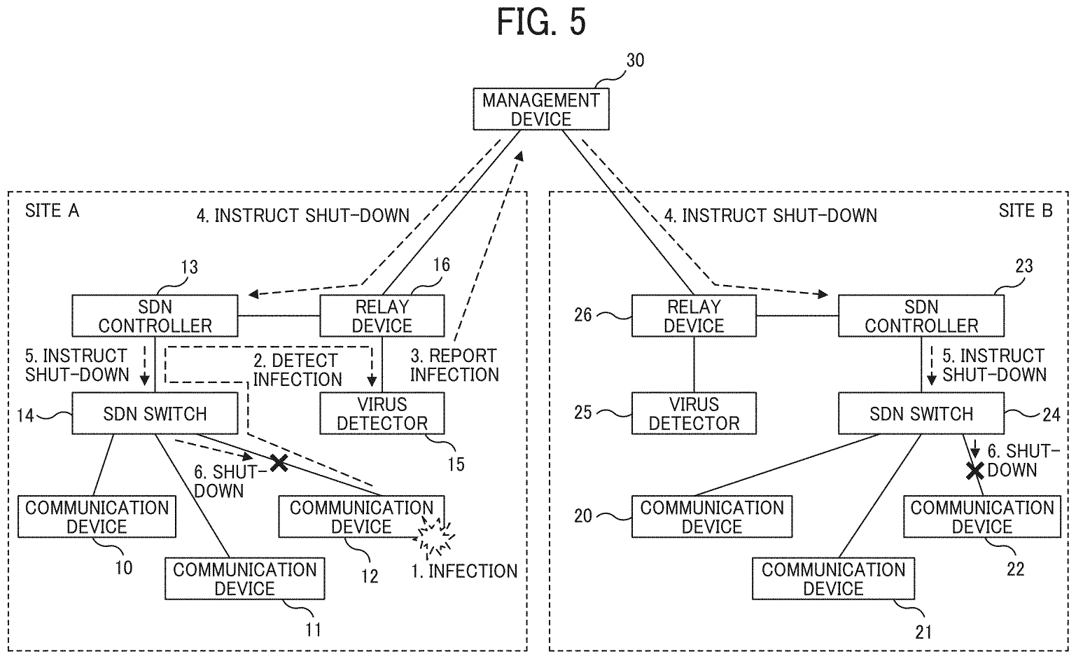

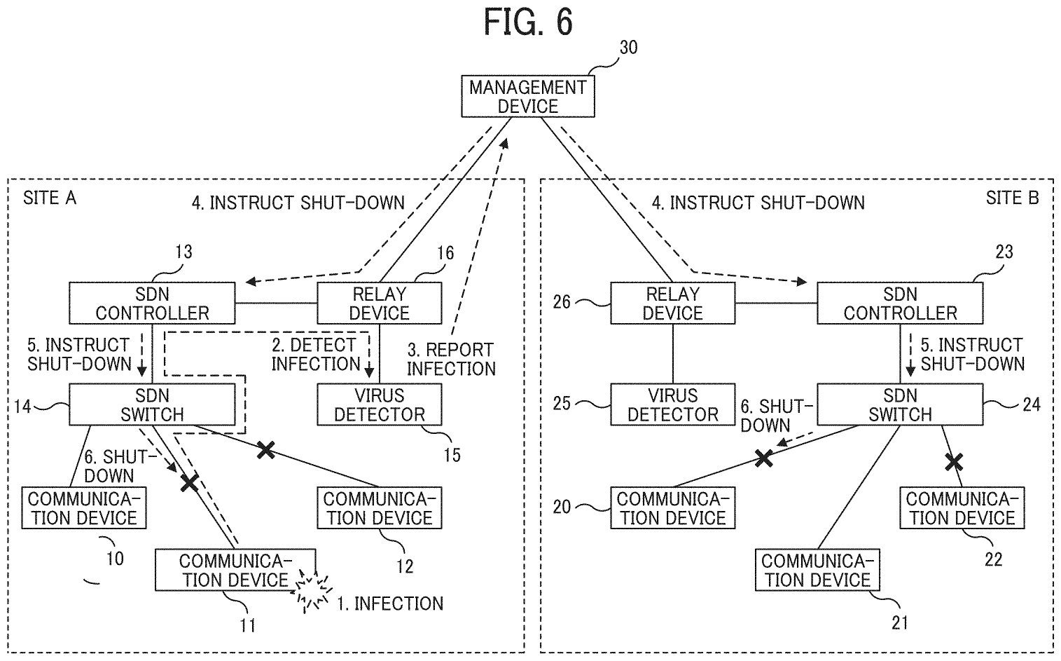

The communication control is described more specifically with reference to FIG. 5 and FIG. 6. FIG. 5 is a diagram illustrating control when virus of the first communication device is detected, and FIG. 6 is a diagram illustrating control when a virus is detected in the second communication device.

The SITE A in FIG. 5 includes the communication devices 10 to 12. The communication device 10 is a PJS. The communication device 11 is an MFP, the model is AAA, and the version is 1.3. The communication device 12 is an MFP, the model is AAA, and the version is 1.2. The SITE B includes the communication devices 20 to 22. The communication device 20 is an MFP, the model is AAA, and the version is 1.4. The communication device 21 is a PJS. The communication device 22 is an MFP, the model is AAA, and the version is 1.2.

For example, when the communication device 12 is infected with a virus (step 1), the virus detector 15 detects the infection from the file transmitted by the communication device 12 (step 2) and notifies the management device 30 that the communication device 12 is infected with the virus (step 3).

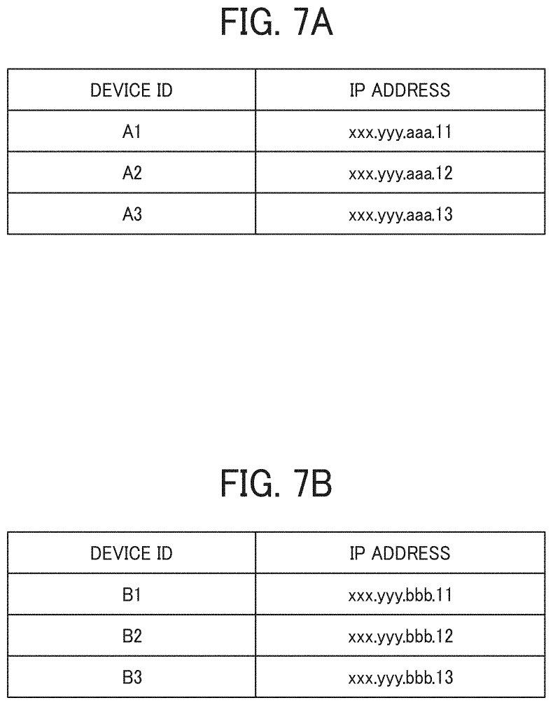

The virus detector 15 is connected to the relay device 16, and transmission and reception of files are performed through the relay device 16 using an internet protocol (IP) address. The relay device 16 associates identification information (device ID) for identifying the communication devices 10 to 12 with address information (IP address) and stores the information as management information as illustrated in FIG. 7A.

The virus detector 15 inquires the relay device 16 using the IP address “xxx.yyy.aaa13” of the communication device 12 detected, acquire identification information (device ID=A3) for identifying the communication device 12, and the acquired device ID is reported as information of the communication device 12. The virus detector 15 reports an IP address as the information of the communication device 12, the relay device 16 relaying the communication between the virus detector 15 and the management device 30 converts the IP address into a device ID, and the converted device ID may be reported to the management device 30.

In response to the notification, the management device 30 refers to the information of the plurality of communication devices managed by the management device 30, and searches for a communication device having the same classification information as the communication device 12.

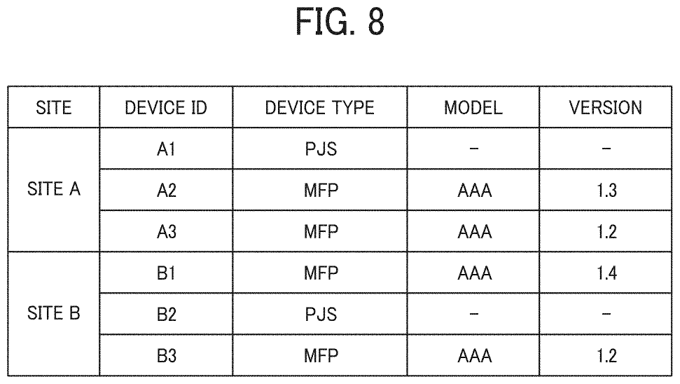

The management device 30 associates the device ID of the communication device at each site with the device type, model, and version information as the classification information, and holds associated information as management information as illustrated in FIG. 8. The management device 30 refers to the management information, and searches for a communication device having information on the device type, model, and version of the device in common with the communication device 12. That is, the management device 30 searches for a communication device that matches the device type “MFP”, the model “AAA”, and the version “1.2” associated with the device ID “A2” of the communication device 12. In this example, the communication device 22 with the device ID “B3” is searched.

Based on the reported information and the search results, the management device 30 instructs the SDN controller 13 that controls communication with the communication device 12 to shut down communication with the communication device 12, and also instructs the SDN controller 23 that controls communication with the communication device 22 to shut down communication with the communication device 22 (step 4).

At this time, the management device 30 sends the device IDs “A3” and “B3” to the relay devices 16 and 26 to acquire the IP addresses “xxx.yyy.aaa13” and “xxx. yyy. bbb13” of the communication devices 12 and 22, and the acquired IP addresses are reported to the SDN controllers 13 and 23 to instruct shut down communication. The relay device 26 also stores management information similar to that of the relay device 16 as illustrated in FIG. 7B.

Also, in this case, the management device 30 notifies the device ID, but the relay devices 16 and 26 that relay communication between the management device 30 and the SDN controllers 13 and 23 may convert the device ID into the IP address, and the converted IP address may be reported to the SDN controllers 13 and 23.

In response to the notification of the IP address, the SDN controllers 13 and 23 instruct the SDN switches 14 and 24 to shut down communication from and to the reported IP address (step 5). The SDN switches 14 and 24 turn off the switches connected to the device having the reported IP address, and shuts down the communication devices 12 and 22 (step 6). Although the communication device 22 is uninfected with the virus, shutting down the communication in this way can prevent the virus.

In the example illustrated in FIG. 6, a second communication device 11 is infected with a virus (step 1). The communication between the first communication device 12 and the communication device 22 has already been shut down.

The virus detector 15 detects an infection from the file transmitted by the communication device 11 (step 2) and notifies the management device 30 that the communication device 11 is infected with the virus (step 3).

In response to the notification, the management device 30 refers to the management information and searches for a communication device having the same classification information as the communication device 11 and the communication device 12. The communication device 11 and the communication device 12 share only the device type and model, so communication devices having the same device type “MFP” and model “AAA” are searched.

The management device 30 identifies the communication devices 12, 20, and 22 as devices having the common classification information, instructs the SDN controller 13 that controls communication with the communication devices 11 and 12 to shut down communication with communication devices 11 and 12, and instructs the SDN controller 23 that controls communication with the communication devices 20 and 22 to shut down communication with the communication devices 20 and 22. Since the management device 30 has already issued an instruction to shut down communication with the communication devices 12 and 22, the management device 30 may instruct to shut down only communication with the communication devices 11 and 20.

The SDN controllers 13, and 23 receive notification of the IP addresses of the communication devices 11, 12, 20, and 22 from the management device 30, and instruct the SDN switches 14 and 24 to shut down communication from and to the reported IP addresses. The SDN switches 14 and 24 turn off the switch connected to the devices having the reported IP addresses, and shut down communication with the communication devices 11, 12, 20 and 22. Since the communication devices 12 and 22 have already been shut down, only the communication devices 11 and 20 are shut down. The communication device 20 is uninfected with the virus but shutting off the communication in advance can prevent the communication device from being infected.

Although the present disclosure has been described using the embodiments described above as the communication control system, the communication control method, and a machine-readable, non-transitory recording medium storing instructions which, when executed by one or more processors, cause the processors to perform the communication control method, the present disclosure is not limited to the aforementioned embodiments. Therefore, the present disclosure can be modified within the scope of those skilled in the art, such as other embodiments, additions, modifications, deletions, etc., and as long as effects of the present disclosure are exhibited in any of the embodiments, the embodiments are included in the scope of the present disclosure. Therefore, according to the present disclosure, it is possible to provide a recording medium in which the above program is recorded, a server device that provides the program through a network, and the like.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A communication control system comprising:
circuitry configured to:
monitor communication of a plurality of communication devices;
detect a first communication device that has made an unauthorized communication;
search for a second communication device having the same classification information as the first communication device, using classification information for classifying each communication device;
issue an instruction to control communication of the first communication device and communication of the second communication device; and
control communication with the first communication device and communication with the second communication device in response to the instruction.

2. The communication control system of claim 1, wherein
when a third communication device different from the first communication device is detected as a communication device that has made an unauthorized communication,
the circuitry issues an instruction to control communication of the third communication device and communication of a fourth communication device having the same classification information as the first communication device and the third communication device.

3. The communication control system of claim 1, wherein
the classification information includes information indicating a device type of each communication device.

4. The communication control system of claim 3, wherein
the circuitry is configured to store in a memory, as the classification information, one or both of information on a model of each communication device and information on a version of basic software for controlling each communication device.

5. The communication control system of claim 1, wherein the circuitry is further configured to;
instruct control of communication link of the first communication device and the second communication device; and
switch the communication link in response to the instruction.

6. The communication control system of claim 5, wherein,
in switching the communication link, the circuitry shuts down the communication link between the first communication device and the second communication device.

7. A communication control method comprising:
monitoring communication of a plurality of communication devices;
detecting a first communication device that has made an unauthorized communication;
searching for a second communication device having the same classification information as the first communication device, using classification information for classifying each communication device;
issuing an instruction to control communication of the first communication device that is detected and communication of the second communication device; and
controlling communication with the first communication device and communication with the second communication device in response to the instruction.

8. The communication control method of claim 7 further comprising:
detecting a third communication device different from the first communication device as a communication device that has made an unauthorized communication;
issuing an instruction to control communication of the third communication device and communication of a fourth communication device having the same classification information as the first communication device and the third communication device; and
controlling communication with the third communication device and communication with the fourth communication device in response to receiving an instruction to control communication.

9. A machine-readable, non-transitory recording medium storing instructions which, when executed by one or more processors, cause the processors to perform a communication control method comprising:
monitoring communication of a plurality of communication devices;
detecting a first communication device that has made an unauthorized communication;
searching for a second communication device having the same classification information as the first communication device, using classification information for classifying each communication device;
issuing an instruction to control communication of the first communication device that is detected and communication of the second communication device; and
controlling communication with the first communication device and communication with the second communication device in response to the instruction.

10. The machine-readable, non-transitory recording medium of claim 9, wherein the communication control method further comprises:
detecting a third communication device different from the first communication device as a communication device that has made an unauthorized communication;
issuing an instruction to control communication of the third communication device and communication of a fourth communication device having the same classification information as the first communication device and the third communication device; and
controlling communication with the third communication device and communication with the fourth communication device in response to receiving an instruction to control communication.
